(19) United States
(12) Patent Application Publication
(10) Pub. No.: US 2014/0361631 A1
(43) Pub. Date: Dec. 11, 2014

(54) COIL DEVICE FOR WIRELESS POWER TRANSMISSION

(71) Applicant: TDK CORPORATION, Tokyo (JP)

(72) Inventors: Akira GOTANI, Tokyo (JP); Kaoru MATSUOKA, Tokyo (JP); Takashi URANO, Tokyo (JP)

(21) Appl. No.: 14/297,019

(22) Filed: Jun. 5, 2014

(30) Foreign Application Priority Data
Jun. 6, 2013 (JP) 2013-119609
Apr. 21, 2014 (JP) 2014-086975

(51) Int. Cl. H01F 38/14; B60L 11/18; H02J 7/02

(52) U.S. Cl. CPC H01F 38/14; H02J 7/025; B60L 11/182
USPC 307/104

(57) ABSTRACT

A coil device for wireless power transmission mounted on a movable body includes a coil body and a magnetic flux conductor. A winding forming the coil body mainly contains aluminum, and the magnetic flux conductor contains a magnetic material and a resin.

### BACKGROUND

The present invention relates to a coil device for wireless power transmission.

### Description of the Related Art

A technology for transmitting power without using a power cord, that is, a so-called wireless power transmission technology is beginning to attract attention. The wireless power transmission technology enables non-contact power supply from a power feeding device to a power receiving device, and thus is expected to be applied to various products, such as movable bodies including trains and electric vehicles, household electric appliances, electronic devices, wireless communication devices, and toys.

To achieve high power transmission efficiency in an apparatus used for wireless power transmission, various studies have been done, for example, on the structure of a conductive member and a winding forming a coil of a coil unit, and on the structure and material of a magnetic body (e.g., see Japanese Unexamined Patent Application Publication No. 2012-70557).

Japanese Unexamined Patent Application Publication No. 2012-70557 discloses a coil unit for a non-contact charging apparatus. The coil unit includes a coil and a magnetic body having a flat surface that supports a backside of the coil. A ferrite body formed by powder compacting is used as the magnetic body. The coil unit is applied to a non-contact charging apparatus of an electric vehicle.

The ferrite body formed by powder compacting described in Japanese Unexamined Patent Application Publication No. 2012-70557 breaks too easily to be mounted on a movable body, such as a vehicle.

In practice, a power consumption rate (Wh/km) is important for a movable body, such as an electric vehicle, and is related to the weight of the movable body. That is, the weight of constituent materials of components, such as a magnetic body and a coil body, mounted on the movable body and contributing to power transmission is one of factors to be considered in improving the power consumption rate. However, Japanese Unexamined Patent Application Publication No. 2012-70557 does not discuss the weight of the magnetic body and the coil body mounted on the movable body, such as an electric vehicle.

### SUMMARY

Accordingly, an object of the present invention is to provide a coil device for wireless power transmission that can improve the power consumption rate of a movable body having a power receiving device or a power feeding device mounted thereon and has good shock resistance.

An aspect of the present invention provides a coil device for wireless power transmission mounted on a movable body and including a coil body and a magnetic flux conductor. A winding forming the coil body mainly contains aluminum, and the magnetic flux conductor contains a magnetic material and a resin.

According to the aspect of the present invention, the winding forming the coil body mainly contains aluminum, and the magnetic flux conductor contains a magnetic material and a resin. This contributes to reduced weight of the coil device for wireless power transmission. The specific gravity of aluminum is about one third of that of copper typically used for windings of coils. The specific gravity of resin is smaller than that of a magnetic material, such as ferrite. Therefore, when the coil device for wireless power transmission having the configuration described above is mounted on a movable body, it is possible to reduce the weight of the movable body and improve the power consumption rate of the movable body. Moreover, since the magnetic flux conductor contains a resin that has better elasticity than a magnetic material, such as ferrite, it is possible to improve shock resistance of the coil device for wireless power transmission. The coil device for wireless power transmission according to the aspect of the present invention is very useful as a coil device mounted on a movable body, which is often subjected to shock.

In the aspect of the present invention, the magnetic flux conductor may include a magnetic material region formed by the magnetic material, and a resin region formed by the resin and covering at least part of the magnetic material region.

In the aspect of the present invention, when the resin region formed by the resin covers at least part of the magnetic material region formed by the magnetic material, it is possible to absorb stress applied to the magnetic material region and prevent chipping in the surface of the magnetic flux conductor.

In the aspect of the present invention, the magnetic flux conductor may include a mixed magnetic material region formed by the magnetic material and the resin, and a resin region formed by the resin and covering at least part of the mixed magnetic material region.

In the aspect of the present invention, when the resin region formed by the resin covers at least part of the mixed magnetic material region formed by the magnetic material and the resin, it is possible to absorb stress applied to the mixed magnetic material region and prevent chipping in the surface of the magnetic flux conductor. Moreover, when the magnetic flux conductor includes the mixed magnetic material region formed by the magnetic material and the resin, it is possible not only to improve shock and breakage resistance of the magnetic flux conductor, but also to achieve further weight reduction.

The coil body is preferably a planar coil or a helical coil, the magnetic flux conductor preferably has a core portion disposed inside the coil body, and the core portion preferably includes, in a central part thereof, a resin region extending continuously in a direction of a winding axis of the coil body.

According to the aspect of the present invention, in the core portion of the magnetic flux conductor, the portion including the central part and extending continuously in the direction of the winding axis of the coil body may be replaced by the resin region. This means that the resin region may be located in an area where the strength of magnetic flux generated when a current flows in the coil body is small. In this case, it is possible to achieve further weight reduction and improved shock resistance while maintaining the power transmission efficiency.

In the coil device according the aspect of the present invention, the coil body is preferably a planar coil; the magnetic flux conductor preferably includes a magnetic material region formed by the magnetic material, and a resin region formed by the resin and covering at least part of the magnetic material region; the magnetic flux conductor preferably has a core portion disposed inside the coil body; the core portion preferably includes a plurality of magnetic material regions and the resin region; and the plurality of magnetic material regions are preferably disposed apart through the resin region.

According to the aspect of the present invention, the plurality of magnetic material regions may be present through the resin region formed by the resin and covering at least part of the magnetic material regions. In this case, stress acting between adjacent magnetic material regions can be absorbed by the resin region. It is thus possible to further improve shock and breakage resistance of the magnetic flux conductor.

In the coil device according the aspect of the present invention, the coil body is preferably a planar coil; the magnetic flux conductor preferably includes a mixed magnetic material region formed by the magnetic material and the resin, and a resin region formed by the resin and covering at least part of the mixed magnetic material region; the magnetic flux conductor preferably has a core portion disposed inside the coil body; the core portion preferably includes a plurality of mixed magnetic material regions and the resin region; and the plurality of mixed magnetic material regions are preferably disposed apart through the resin region.

According to the aspect of the present invention, the plurality of mixed magnetic material regions formed by the magnetic material and the resin may be present through the resin region formed by the resin and covering at least part of the mixed magnetic material regions. In this case, stress acting between adjacent mixed magnetic material regions can be absorbed by the resin region. It is thus possible to further improve shock and breakage resistance of the magnetic flux conductor. Additionally, when the core portion includes the mixed magnetic material regions formed by the magnetic material and the resin, it is possible to further reduce the breakage of the magnetic flux conductor and achieve further weight reduction.

In the coil device according the aspect of the present invention, the coil body is preferably a helical coil; the magnetic flux conductor preferably includes a magnetic material region formed by the magnetic material, and a resin region formed by the resin and covering at least part of the magnetic material region; the magnetic flux conductor preferably has a core portion disposed inside the coil body; and preferably a plurality of magnetic material regions and a plurality of resin regions are alternately arranged in the core portion.

According to the aspect of the present invention, the plurality of magnetic material regions formed by the magnetic material and the plurality of resin regions formed by the resin and covering at least part of the magnetic material regions may be alternately arranged. In this case, stress applied between the magnetic material regions can be absorbed by the resin regions. It is thus possible to further improve shock and breakage resistance of the magnetic flux conductor.

In the coil device according the aspect of the present invention, the coil body is preferably a helical coil; the magnetic flux conductor preferably includes a mixed magnetic material region formed by the magnetic material and the resin, and a resin region formed by the resin and covering at least part of the mixed magnetic material region; the magnetic flux conductor preferably has a core portion disposed inside the coil body; and preferably a plurality of mixed magnetic material regions and a plurality of resin regions are alternately arranged in the core portion.

According to the aspect of the present invention, the plurality of resin regions formed by the resin and covering at least part of the mixed magnetic material regions and the plurality of mixed magnetic material regions formed by the magnetic material and the resin may be alternately arranged. In this case, stress applied between the mixed magnetic material regions can be absorbed by the resin regions. It is thus possible to further improve shock and breakage resistance of the magnetic flux conductor. Additionally, when the core portion includes the mixed magnetic material regions formed by the magnetic material and the resin, it is possible to further reduce the breakage of the magnetic flux conductor and achieve further weight reduction.

According to the aspect of the present invention, it is possible to provide a coil device for wireless power transmission that can improve the power consumption rate of a movable body having a power receiving device and a power feeding device mounted thereon and has good shock resistance.

### BRIEF DESCRIPTION OF THE DRAWINGS

FIG. 1 is a schematic diagram illustrating how a coil device of the present invention is applied to a wireless power transmission apparatus of an electric vehicle.

FIG. 2 is a perspective view of a coil device for wireless power transmission according to a first embodiment of the present invention.

FIG. 3 is a perspective view of a coil device for wireless power transmission according to a second embodiment of the present invention.

FIG. 4 is a perspective view of a coil device for wireless power transmission according to a modification of the first embodiment of the present invention.

FIG. 5 is a perspective view of a coil device for wireless power transmission according to a modification of the second embodiment of the present invention.

FIG. 6 is a perspective view of a coil device for wireless power transmission according to a third embodiment of the present invention.

FIG. 7 is a perspective view of a coil device for wireless power transmission according to a fourth embodiment of the present invention.

### DETAILED DESCRIPTION OF EMBODIMENTS

Preferred embodiments of the present invention will be described in detail with reference to the drawings, but the present invention is not limited to the following embodiments. In the following description, the same or corresponding parts are given the same reference numerals and duplicate description will be omitted.

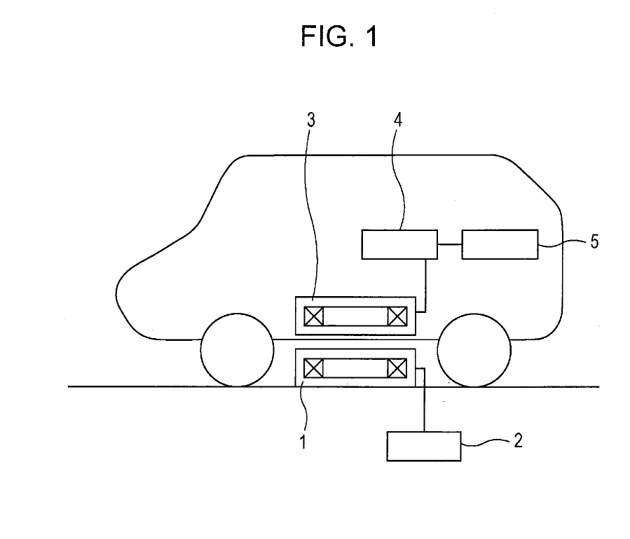

FIG. 1 is a schematic diagram illustrating how a coil device of the present invention is applied to a wireless power transmission apparatus of an electric vehicle. The wireless power transmission apparatus of the present embodiment includes a power-feeding coil device 1, an alternating-current power supply 2, a power-receiving coil device 3, a rectifier 4, and a battery 5.

The power-feeding coil device 1 that supplies power is installed on the ground such that generated magnetic fluxes flow toward the power-receiving coil device 3. The power-feeding coil device 1 is connected to the alternating-current power supply 2. The power-receiving coil device 3 to which power is transmitted from the power-feeding coil device 1, the rectifier 4, and the battery 5 are mounted on the electric vehicle. The power-receiving coil device 3 is installed, for example, on a floor surface of the electric vehicle such that magnetic fluxes from the power-feeding coil device 1 are interlinked. The power-receiving coil device 3 is connected to the rectifier 4, which is connected to the battery 5 serving as a secondary battery. The electric vehicle is charged, with a coil body of the power-receiving coil device 3 facing a coil body of the power-feeding coil device 1.

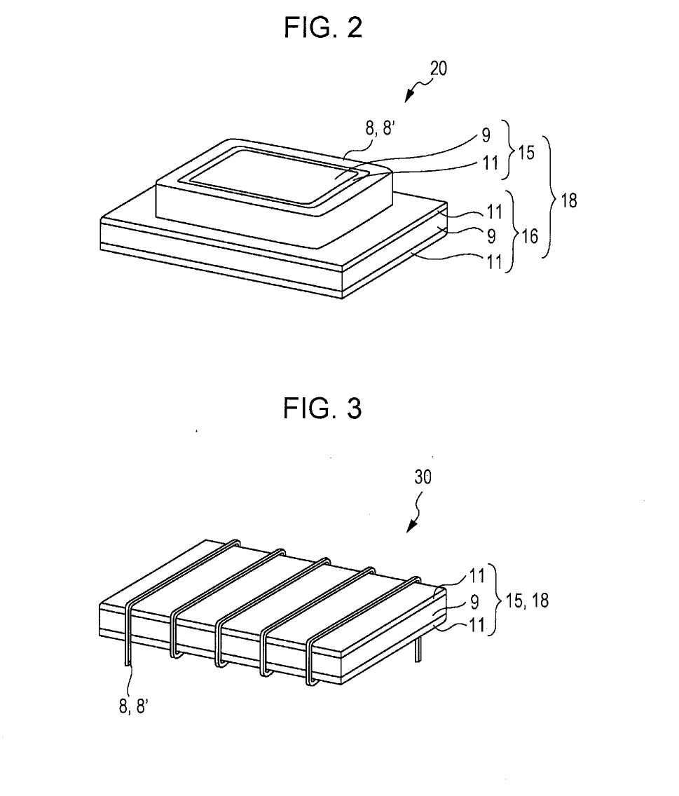

FIG. 2 is a perspective view of a coil device for wireless power transmission according to a first embodiment of the present invention. FIG. 3 is a perspective view of a coil device for wireless power transmission according to a second embodiment of the present invention. Coil devices 20 and 30 each include a coil body 8 and a magnetic flux conductor 18. A winding 8′ that forms the coil body 8 mainly contains aluminum, and the magnetic flux conductor 18 contains a magnetic material and a resin. The coil body 8 in FIG. 2 is a planar coil, and the coil body 8 in FIG. 3 is a helical coil.

### First Embodiment

When the coil body 8 is a planar coil as illustrated in FIG. 2, the magnetic flux conductor 18 has a core portion 15 and a flat portion 16. The core portion 15 is disposed inside the coil body 8 wound in a planar rectangular shape. When the core portion 15 is disposed inside the coil body 8, magnetic fluxes generated for transmitting power to a power-receiving coil device disposed opposite the coil device 20 or magnetic fluxes generated from a power-feeding coil device disposed opposite the coil device 20 can be concentrated in the core portion 15, so that power transmission efficiency can be improved. The flat portion 16 is disposed on one of two coil surfaces of the coil body 8. The term “coil surface” in the present embodiment refers to a coil principal surface having an opening. The flat portion 16 is disposed on one of the two coil surfaces of the coil body 8, the one being a surface opposite the surface which is to face the power-receiving or power-feeding coil device disposed opposite the coil device 20. When the flat portion 16 is disposed on one of the two coil surfaces of the coil body 8, it is possible to reduce flux leakage from the coil body 8 and improve power transmission efficiency.

Of all surfaces of the core portion 15, those around which the coil body 8 is not wound are hereinafter referred to as “end surfaces of the core portion 15”. A positional relationship between an end surface of the core portion 15 distant from the flat portion 16 and a coil surface of the coil body 8 distant from the flat portion 16 will now be described. The end surface of the core portion 15 may protrude from the coil surface of the coil body 8, may be flush with the coil surface of the coil body 8, or may be recessed from the coil surface of the coil body 8. To reduce the sizes of the power-receiving coil device 3 and the power-feeding coil device 1 and improve power transmission efficiency, it is preferable that the end surface of the core portion 15 distant from the flat portion 16 be flush with the coil surface of the coil body 8 distant from the flat portion 16.

The magnetic flux conductor 18 may include a magnetic region 9 and an elastic region 11. The magnetic region 9 is a magnetic material region formed by a magnetic material, or a mixed magnetic material region formed by a magnetic material and a resin. The mixed magnetic material region formed by the magnetic material and the resin preferably contains not less than 90% by mass of magnetic material, more preferably contains not less than 95% by mass of magnetic material, still more preferably contains not less than 98% by mass of magnetic material, and particularly preferably contains not less than 99% by mass of magnetic material, based on the total amount of the mixed magnetic material region. The elastic region 11 is a resin region containing resin as a main component. For lighter weight and easier manufacture, the elastic region 11 is preferably a resin region formed by a resin. The magnetic region (hereinafter referred to as a “magnetic material region” or a “mixed magnetic material region”) 9 and the elastic region (hereinafter referred to as a “resin region”) 11 may contain impurities as long as each region has intended functional effects. The elastic region 11 covers at least part of the magnetic material region 9 or mixed magnetic material region 9.

For example, as illustrated in FIG. 2, the resin region 11 of the core portion 15 covers part of the surface of the magnetic material region 9 or mixed magnetic material region 9 around which the coil body 8 is to be wound. The coil body 8 and the magnetic material region 9 or mixed magnetic material region 9 are arranged or joined together, with the resin region 11 interposed therebetween. Since the resin region 11 is interposed between the coil body 8 and the magnetic material region 9 or mixed magnetic material region 9, it is possible to prevent cracking and chipping in the surface of the magnetic material region 9 or mixed magnetic material region 9 caused by contact between the coil body 8 and the magnetic material region 9 or mixed magnetic material region 9 resulting from vibration of a moving electric vehicle.

In the flat portion 16, two opposite principal surfaces of the magnetic material region 9 or mixed magnetic material region 9 having a flat rectangular shape are coated with respective resin regions 11. Of the two resin regions 11 in the flat portion 16, the resin region 11 having a surface in contact with the coil surface of the coil body 8 can not only give elasticity to the flat portion 16, but can also be joined to the coil body 8. In a direction perpendicular to the principal surfaces of the magnetic material region 9 or mixed magnetic material region 9, stress is applied, for example, by vibration of a moving electric vehicle in a vertical direction (i.e., direction of gravity). Since the two resin regions 11 in the flat portion 16 are disposed on the respective two opposite principal surfaces of the magnetic material region 9 or mixed magnetic material region 9, it is possible to prevent cracking and chipping in the surface of the magnetic material region 9 or mixed magnetic material region 9 and breakage of the magnetic material region 9 or mixed magnetic material region 9 caused, for example, by contact between the coil body 8 or a housing (not shown) covering the coil device 20 and the magnetic material region 9 or mixed magnetic material region 9.

In the present embodiment, the magnetic material region 9 or mixed magnetic material region 9 of each of the core portion 15 and the flat portion 16 is coated with the resin region (regions) 11. However, the effect of shock resistance can be achieved as long as the magnetic material region 9 or mixed magnetic material region 9 of one of the core portion 15 and the flat portion 16 is coated with the resin region (regions) 11. In the core portion 15, the resin region 11 preferably covers not less than 50% of an interfacial area between the coil body 8 and the magnetic material region 9 or mixed magnetic material region 9, more preferably covers not less than 75% of the interfacial area, and still more preferably covers not less than 90% of the interfacial area. When the coverage of the interfacial area increases, the cracking and chipping in the surface of the magnetic material region 9 or mixed magnetic material region 9 can be more effectively reduced. In the flat portion 16, each resin region 11 preferably covers not less than 50% of an area of one principal surface of the magnetic material region 9 or mixed magnetic material region 9, more preferably covers not less than 75% of the area, and still more preferably covers not less than 90% of the area. When the coverage of the principal surface increases, the cracking and chipping in the surface of the magnetic material region 9 or mixed magnetic material region 9 can be more effectively reduced. Additionally, it is possible to more effectively reduce the breakage of the magnetic material region 9 or mixed magnetic material region 9 caused by stress resulting from vibration of the moving electric vehicle in the vertical direction (i.e., direction of gravity).

For better shock resistance, it is particularly preferable, in the flat portion 16, that the resin regions 11 cover not only the two opposite principal surfaces but also side surfaces of the magnetic material region 9 or mixed magnetic material region 9. That is, it is particularly preferable that the resin regions 11 of the flat portion 16 cover all the surfaces of the magnetic material region 9 or mixed magnetic material region 9.

For higher power transmission efficiency and easier manufacture, it is preferable for the magnetic flux conductor 18 to include the magnetic material region 9. For lighter weight and better shock resistance (in particular, breakage resistance of the magnetic flux conductor 18), it is preferable for the magnetic flux conductor 18 to include the mixed magnetic material region 9 formed by a magnetic material and a resin.

For easy achievement of desired magnetic characteristics and easy formation of desired shapes, a soft magnetic material is preferably used as the magnetic material. A soft magnetic powder or a soft magnetic powder compact may be used as the magnetic material. The soft magnetic material is not limited to a specific one, but is preferably one that has high magnetic permeability and high electrical resistance. For example, a soft magnetic material with low eddy current loss in a high-frequency region, such as manganese zinc ferrite, nickel zinc ferrite, or copper zinc ferrite, may be used.

The resin is preferably one that can absorb stress applied to the magnetic material region 9 or mixed magnetic material region 9. Examples of the resin include phenol resin, epoxy resin, unsaturated polyester resin, polyamide, polyurethane, silicone rubber, chloroprene rubber, fluoro rubber, butyl rubber, nitrile rubber, natural rubber, and a mixture containing some of them as main components. The resin that forms the resin region 11 may be the same as that forms the mixed magnetic material region 9. The mixed magnetic material region 9 is formed, for example, by mixing a liquid polymeric material with a soft magnetic powder. An intended shape can be formed by hardening the mixture of the polymeric material and the soft magnetic powder.

The winding 8′ that forms the coil body 8 mainly contains aluminum. Examples of the winding 8′ include an aluminum wire and a copper-clad aluminum wire. Using either of these wires makes it possible to achieve a lighter weight and improve a power consumption rate of a movable body, such as an electric vehicle, than those in the case of using a copper wire which is typically used as a winding of a coil. To achieve both weight reduction and high electrical conductivity, it is preferable to use a copper-clad aluminum wire, which is an aluminum wire uniformly coated with copper. The copper-clad aluminum wire may be used as a litz wire formed by a number of strands.

The coil body 8 which is planar in shape and whose cross-section perpendicular to a winding axis of the coil body 8 is wound in a rectangular shape is used, but the shape of the coil body 8 is not limited to this. For example, the cross-section of the coil body 8 may be circular, elliptical, or polygonal. Although the core portion 15 having a quadratic prism-like outer shape is used, an appropriate outer shape of the core portion 15 may be selected depending on the shape of the coil body 8. For example, the core portion 15 may be circular cylindrical, elliptic cylindrical, or polygonal columnar in outer shape. At the same time, although the flat portion 16 having a quadratic prism-like outer shape is used, the flat portion 16 may also be circular cylindrical, elliptic cylindrical, or polygonal columnar in outer shape.

### Second Embodiment

As illustrated in FIG. 3, in the coil device 30 in which the coil body 8 is a helical coil, the core portion 15 serving as the magnetic flux conductor 18 is disposed inside the helical coil body 8. The coil body 8 is helical in shape and its cross-section perpendicular to a winding axis of the coil body 8 is wound in a rectangular shape. The core portion 15 includes the magnetic region 9 and the elastic regions 11. The constituent components of these regions are the same as those of the magnetic regions 9 and the elastic regions 11 forming the magnetic flux conductor 18 of the first embodiment. When the core portion 15 is disposed inside the coil body 8, magnetic fluxes generated for transmitting power to a power-receiving coil device disposed opposite the coil device 30 or magnetic fluxes generated from a power-feeding coil device disposed opposite the coil device 30 can be concentrated in the core portion 15, so that power transmission efficiency can be improved.

In the core portion 15, two opposite principal surfaces of the magnetic material region 9 or mixed magnetic material region 9 having a flat rectangular shape are coated with the respective resin regions 11. In a direction perpendicular to the principal surfaces of the magnetic material region 9 or mixed magnetic material region 9, stress is applied, for example, by vibration of a moving electric vehicle in a vertical direction (i.e., direction of gravity). Since the two resin region 11 in the core portion 15 are disposed on the respective two opposite principal surfaces of the magnetic material region 9 or mixed magnetic material region 9, it is possible to prevent cracking and chipping in the surface of the magnetic material region 9 or mixed magnetic material region 9 and breakage of the magnetic material region 9 or mixed magnetic material region 9 caused, for example, by contact between the coil body 8 and the magnetic material region 9 or mixed magnetic material region 9.

Each resin region 11 preferably covers not less than 50% of an area of one principal surface of the magnetic material region 9 or mixed magnetic material region 9, more preferably covers not less than 75% of the area, and still more preferably covers not less than 90% of the area. When the coverage of the principal surface increases, the cracking and chipping in the surface of the magnetic material region 9 or mixed magnetic material region 9 can be more effectively reduced. Additionally, it is possible to more effectively reduce the breakage of the magnetic material region 9 or mixed magnetic material region 9 caused by stress resulting from vibration of the moving electric vehicle in the vertical direction (i.e., direction of gravity). For better shock resistance, it is particularly preferable that the resin regions 11 cover not only the two opposite principal surfaces but also side surfaces of the magnetic material region 9 or mixed magnetic material region 9. That is, it is particularly preferable that the resin regions 11 cover all the surfaces of the magnetic material region 9 or mixed magnetic material region 9.

For higher power transmission efficiency and easier manufacture, it is preferable for the core portion 15 to include the magnetic material region 9. For lighter weight and better shock resistance (in particular, breakage resistance of the magnetic flux conductor 18), it is preferable for the core portion 15 to include the mixed magnetic material region 9 formed by a magnetic material and a resin.

The coil body 8 which is helical in shape and whose cross-section perpendicular to a winding axis of the coil body 8 is wound in a rectangular shape is used, but the shape of the coil body 8 is not limited to this. For example, the cross-section of the coil body 8 may be wound in a circular, elliptical, or polygonal shape. An appropriate outer shape of the core portion 15 may be selected depending on the shape of the coil body 8. The core portion 15 may be circular cylindrical, elliptic cylindrical, or prismatic in outer shape.

In the coil device for wireless power transmission according to the first and second embodiments, the winding 8′ forming the coil body 8 mainly contains aluminum, and the magnetic flux conductor 18 includes the magnetic material region 9 or mixed magnetic material region 9 and the resin region 11 (preferably, the resin region 11 that covers at least part of the magnetic material region 9 or mixed magnetic material region 9). This makes it possible to provide a coil device for wireless power transmission that can improve the power consumption rate of a movable body, such as an electric vehicle, and has good shock resistance.

### Modifications of First and Second Embodiments

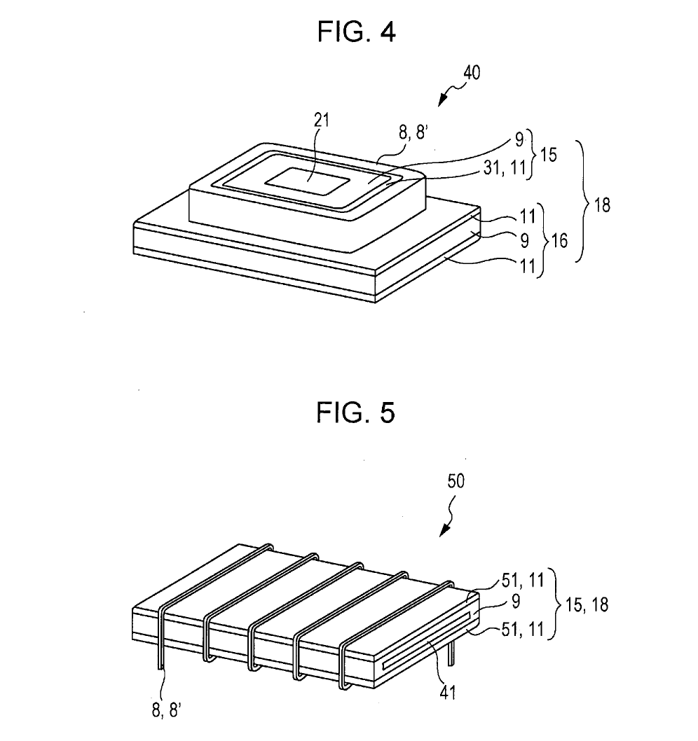

FIG. 4 is a perspective view of a coil device for wireless power transmission according to a modification of the first embodiment of the present invention. FIG. 5 is a perspective view of a coil device for wireless power transmission according to a modification of the second embodiment of the present invention.

A coil device 40 according to the modification of the first embodiment illustrated in FIG. 4 is obtained by replacing an inside part of the magnetic material region 9 or mixed magnetic material region 9 in the coil device for wireless power transmission according to the first embodiment with a resin region 21. This can not only reduce the weight of the coil device for wireless power transmission, but can also more effectively reduce the breakage of the magnetic material region 9 or mixed magnetic material region 9 caused by stress resulting from vibration of a moving electric vehicle in a vertical direction (i.e., direction of gravity).

The coil body 8 is a planar coil, and the magnetic flux conductor 18 has the core portion 15 disposed inside the coil body 8. The core portion 15 includes, in a central part thereof, the resin region 21 extending continuously in the direction of the winding axis of the coil body 8. The term “winding axis” refers to a central axis around which a linear wire is wound into a winding to form the coil body 8.

Specifically, the core portion 15 of the magnetic flux conductor 18 includes the resin region (first resin region) 21, the magnetic material region 9 or mixed magnetic material region 9 that covers the first resin region 21, and a second resin region 31 (11) that covers the magnetic material region 9 or mixed magnetic material region 9 and contains resin as a major component. The first resin region 21 forms the central axis of the magnetic flux conductor 18 by being densely filled with a material containing resin as a major component along the direction of magnetic fluxes generated in the coil device 40. The constituent components of the first resin region 21 and the second resin region 31 (11) are the same as those of the elastic region 11 according to the first embodiment.

In the core portion 15 of the magnetic flux conductor 18, the portion including the central part and extending continuously in the direction of the winding axis of the coil body 8 is replaced by the resin region 21. This means that the resin region 21 is located in an area where the strength of magnetic flux generated when a current flows in the coil body 8 is small. It is thus possible to achieve further weight reduction and improved shock resistance while maintaining the power transmission efficiency. For further weight reduction, a part of the core portion 15 corresponding to the resin region 21 may be left hollow. To achieve both weight reduction and good shock resistance, the inner wall of the hollow space of the core portion 15 may be coated with resin (or material having constituent components which are the same as those of the elastic region 11 in the first embodiment).

While not shown, in the flat portion 16 of the magnetic flux conductor 18, a resin region corresponding to the resin region 21 may extend continuously along the winding axis of the coil body 8, in the central part of the magnetic material region 9 or mixed magnetic material region 9. For further weight reduction, a part of the flat portion 16 corresponding to the resin region 21 may be left hollow. To achieve both weight reduction and good shock resistance, the inner wall of the hollow space of the flat portion 16 may be coated with resin (or material having constituent components which are the same as those of the elastic region 11 in the first embodiment).

A coil device 50 according to the modification of the second embodiment illustrated in FIG. 5 is obtained by replacing an inside part of the magnetic material region 9 or mixed magnetic material region 9 in the coil device for wireless power transmission according to the second embodiment with a resin region 41.

The coil body 8 is a helical coil, and the magnetic flux conductor 18 has the core portion 15 disposed inside the coil body 8. The core portion 15 includes, in a central part thereof, the resin region 41 extending continuously in the direction of the winding axis of the coil body 8. The term “winding axis” refers to a central axis around which a linear wire is wound into a winding to form the coil body 8.

Specifically, the magnetic flux conductor 18 includes the resin region (first resin region) 41, the magnetic material region 9 or mixed magnetic material region 9 that covers the first resin region 41, and second resin regions 51 (11) that cover the magnetic material region 9 or mixed magnetic material region 9 and contain resin as a major component. The first resin region 41 forms the central axis of the magnetic flux conductor 18 by being densely filled with a material containing resin as a major component along the direction of magnetic fluxes generated in the coil device 50. The constituent components of the first resin region 41 and the second resin regions 51 (11) are the same as those of the elastic region 11 according to the second embodiment.

In the core portion 15 of the magnetic flux conductor 18, the portion including the central part and extending continuously in the direction of the winding axis of the coil body 8 is replaced by the resin region 41. This means that the resin region 41 is located in an area where the strength of magnetic flux generated when a current flows in the coil body 8 is small. It is thus possible to achieve further weight reduction and improved shock resistance while maintaining the power transmission efficiency. For further weight reduction, a part of the core portion 15 corresponding to the resin region 41 may be left hollow. To achieve both weight reduction and good shock resistance, the inner wall of the hollow space of the core portion 15 may be coated with resin (or material having constituent components which are the same as those of the elastic region 11 in the second embodiment).

### Third Embodiment

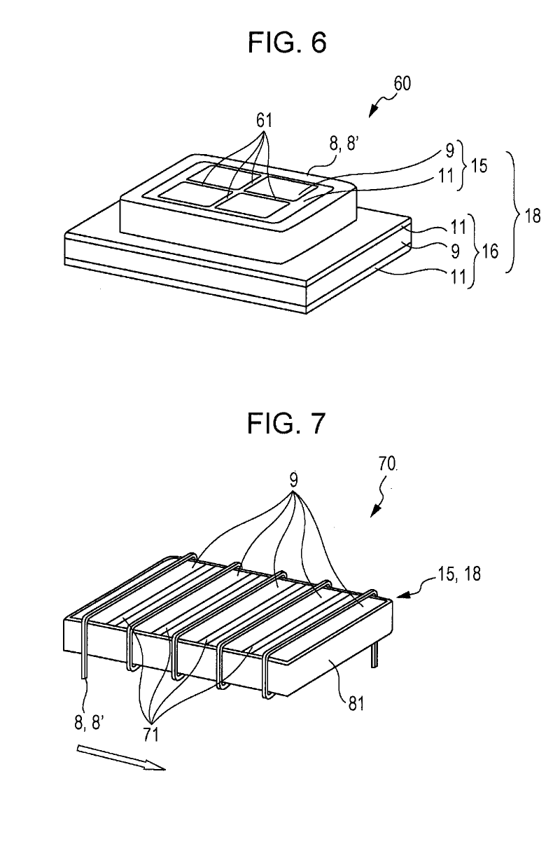

FIG. 6 is a perspective view of a coil device for wireless power transmission according to a third embodiment of the present invention. A coil device 60 according to the present embodiment has a configuration in which, in the core portion 15 of the first embodiment, a plurality of magnetic regions 9 are spaced apart by an elastic region 61. At least part of the magnetic regions 9 is covered by the elastic region 61. The constituent components of the magnetic regions 9 and the constituent components of the elastic region 61 in the core portion 15 of the present embodiment are the same as the constituent components of the magnetic region 9 and the constituent components of the elastic region 11 in the core portion 15 of the first embodiment. Therefore, hereinafter, the magnetic regions 9 will be referred to as “magnetic material regions 9 or mixed magnetic material regions 9”, and the elastic region 61 will be referred to as “resin region 61”.

Specifically, for example, the plurality of magnetic material regions 9 or mixed magnetic material regions 9 are arranged in respective spaces of the grid-like resin region 61, and the coil body 8 and the magnetic material regions 9 or mixed magnetic material regions 9 are arranged or joined together, with the resin region 11 interposed therebetween. Since the plurality of magnetic material regions 9 or mixed magnetic material regions 9 are present through resin region 61, stress acting between adjacent magnetic material regions 9 or mixed magnetic material regions 9 is absorbed by the resin region 61. It is thus possible to further improve shock and breakage resistance of the magnetic flux conductor 18. The magnetic material regions 9 or mixed magnetic material regions 9 are preferably sized to reduce heat generated by concentration of magnetic fluxes.

To improve shock resistance (in particular, to reduce cracking and chipping in the surfaces of the magnetic material regions 9 or mixed magnetic material regions 9), the resin region 11 preferably covers not less than 50% of an interfacial area between the coil body 8 and the plurality of magnetic material regions 9 or mixed magnetic material regions 9, more preferably covers not less than 75% of the interfacial area, still more preferably covers not less than 90% of the interfacial area, and particularly preferably covers the entire interfacial area.

The core portion 15 can be made, for example, by filling a plurality of through-holes or holes having bottoms in a resin body, with a magnetic material, a mixture of magnetic material and resin, or both of them. Alternatively, the core portion 15 may be made by dipping a plurality of small pieces of magnetic material or a plurality of small pieces of mixture of magnetic material and resin into a resin paste melted by heating, forming resin films on the surfaces of the small pieces of magnetic material or the small pieces of mixture of magnetic material and resin, arranging the small pieces each having a resin film on the surface thereof, and applying pressure from around toward the center a collection of the small pieces. The small pieces of magnetic material each having a resin film on the surface thereof, and the small pieces of mixture each having a resin film on the surface thereof may be used in combination. By using both the small pieces of magnetic material and the small pieces of mixture of magnetic material and resin, it is possible to achieve improved shock resistance (in particular, breakage resistance of the core portion 15) and further weight reduction while maintaining the power transmission efficiency.

Although the plurality of magnetic material regions 9 or mixed magnetic material regions 9 are rectangular in outer shape in the present embodiment, they may be circular cylindrical, elliptic cylindrical, or polygonal columnar in outer shape.

In the coil device for wireless power transmission 60 according to the present embodiment, it is possible to absorb stress applied from various directions to the magnetic flux conductor 18 by vibration of a moving electric vehicle, and particularly to prevent cracking and chipping in the surface of the core portion 15 of the planar coil and breakage of the core portion 15.

### Fourth Embodiment

FIG. 7 is a perspective view of a coil device for wireless power transmission according to a fourth embodiment of the present invention. A coil device 70 according to the present embodiment has a configuration in which, in the core portion 15 of the second embodiment, a plurality of magnetic regions 9 and a plurality of elastic regions 71 are alternately arranged and all side surfaces of the plurality of magnetic regions 9 and the plurality of elastic regions 71 are covered by an elastic region 81. At least part of the magnetic regions 9 is covered by the elastic regions 71 and 81. The constituent components of the magnetic regions 9 and the constituent components of the elastic regions 71 and 81 in the core portion 15 of the present embodiment are the same as the constituent components of the magnetic region 9 and the constituent components of the elastic regions 11 in the core portion 15 of the second embodiment. Therefore, hereinafter, the magnetic regions 9 will be referred to as “magnetic material regions 9 or mixed magnetic material regions 9”, and the elastic regions 71 and 81 will be referred to as “resin regions 71 and 81”. By using both the magnetic material region 9 and the mixed magnetic material region 9 as the magnetic regions 9, it is possible to achieve improved shock resistance (in particular, breakage resistance of the core portion 15) and further weight reduction while maintaining the power transmission efficiency.

Specifically, strip-like magnetic material regions 9 or mixed magnetic material regions 9 and strip-like resin regions 71 are alternately arranged along a direction perpendicular to the winding axis of the coil body 8, that is, a central axis (i.e., the direction of arrow in FIG. 7) around which the winding 8′ is wound. All the side surfaces of the plurality of magnetic material regions 9 or mixed magnetic material regions 9 and the plurality of resin regions 71 are covered by the resin region 81. The magnetic material regions 9 or mixed magnetic material regions 9 can be joined together by the resin regions 71 therebetween and the resin region 81 therearound. For better shock resistance, it is particularly preferable that the resin region 81 cover not only the side surfaces of the plurality of magnetic material regions 9 or mixed magnetic material regions 9 and the plurality of resin regions 71, but also two opposite principal surfaces of the plurality of magnetic material regions 9 or mixed magnetic material regions 9 and the plurality of resin regions 71. That is, for better shock resistance, it is particularly preferable that the all the surfaces of the plurality of magnetic material regions 9 or mixed magnetic material regions 9 and the plurality of resin regions 71 be covered by the resin region 81.

The core portion 15 can be made, for example, by alternately arranging small strip-like (rectangular) pieces of magnetic material or mixture of magnetic material and resin and small strip-like (rectangular) pieces of resin, heating them until resin surfaces are melted, applying pressure to an end of the collection of these pieces in the direction of the arrangement, and covering the entire periphery of the collection with a resin tape or the like.

To reduce heat generated by concentration of magnetic fluxes in the magnetic material regions 9 or mixed magnetic material regions 9 and prevent breakage of the magnetic material regions 9 or mixed magnetic material regions 9, it is preferable, as illustrated in FIG. 7, that the magnetic material regions 9 or mixed magnetic material regions 9 and the resin regions 71 be alternately arranged along a direction perpendicular to the direction around which the winding 8′ or coil body 8 is wound (i.e., the direction of arrow in FIG. 7). To prevent an increase of magnetic reluctance, the width of each of the magnetic material regions 9 or mixed magnetic material regions 9 in the direction of arrow in FIG. 7 is preferably longer than that of each of the resin regions 71 in the direction of arrow in FIG. 7, and the length of each of the resin regions 71 in the direction of arrow in FIG. 7 is preferably several micrometers (μm) to several tens of micrometers.

To prevent breakage of the magnetic flux conductor 18 while maintaining the power transmission efficiency, the strip-like magnetic material regions 9 or mixed magnetic material regions 9 and the strip-like resin regions 71 may be arranged along the direction around which the winding 8′ or coil body 8 is wound (i.e., the direction of arrow in FIG. 7).

The shape of the magnetic material regions 9 or mixed magnetic material regions 9 and the resin regions 71 is not limited to the strip-like shape illustrated in FIG. 7. The magnetic material regions 9 or mixed magnetic material regions 9 and the resin regions 71 may have the shape of a triangular prism, a quadratic prism which is parallelogram or diamond-shaped on the principal surface side of the core portion 15, or a hexagonal prism, or may have the shapes of some of them.

In the coil device for wireless power transmission 70 according to the present embodiment, the plurality of magnetic material regions 9 or mixed magnetic material regions 9 and the plurality of resin regions 71 are alternately arranged and all the side surfaces of the plurality of magnetic material regions 9 or mixed magnetic material regions 9 and the plurality of resin regions 71 are covered by the resin region 81. Therefore, it is possible to absorb stress applied from various directions to the magnetic flux conductor 18 by vibration of a moving electric vehicle, and to further reduce breakage of the magnetic flux conductor 18 and cracking and chipping in the surface of the magnetic flux conductor 18.

Although the movable body is an electric vehicle in the first to fourth embodiments described above, the movable body of the present invention is not limited to this. The movable body may be any structure that has a surface in contact with the ground and moves using electrical energy. Examples of the movable body include not only an electric vehicle, but also a plug-in hybrid vehicle, an electric motorcycle, and an electric bicycle. Although the movable body is supplied with power in the description above, the same effect is also achieved when the movable body is configured to supply power.

What is claimed is:

1. A coil device for wireless power transmission mounted on a movable body, the coil device comprising:
a coil body; and
a magnetic flux conductor,
wherein a winding forming the coil body mainly contains aluminum; and
the magnetic flux conductor contains a magnetic material and a resin.

2. The coil device for wireless power transmission according to claim 1, wherein the magnetic flux conductor includes a magnetic material region formed by the magnetic material, and a resin region formed by the resin and covering at least part of the magnetic material region.

3. The coil device for wireless power transmission according to claim 1, wherein the magnetic flux conductor includes a mixed magnetic material region formed by the magnetic material and the resin, and a resin region formed by the resin and covering at least part of the mixed magnetic material region.

4. The coil device for wireless power transmission according to claim 1, wherein the coil body is a planar coil;
the magnetic flux conductor has a core portion disposed inside the coil body; and
the core portion includes, in a central part thereof, a resin region extending continuously in a direction of a winding axis of the coil body.

5. The coil device for wireless power transmission according to claim 1, wherein the coil body is a helical coil;
the magnetic flux conductor has a core portion disposed inside the coil body; and
the core portion includes, in a central part thereof, a resin region extending continuously in a direction of a winding axis of the coil body.

6. The coil device for wireless power transmission according to claim 2, wherein the coil body is a planar coil;
the magnetic flux conductor has a core portion disposed inside the coil body;
the core portion includes a plurality of magnetic material regions and the resin region; and
the plurality of magnetic material regions are disposed apart through the resin region.

7. The coil device for wireless power transmission according to claim 3, wherein the coil body is a planar coil;
the magnetic flux conductor has a core portion disposed inside the coil body;
the core portion includes a plurality of mixed magnetic material regions and the resin region; and
the plurality of mixed magnetic material regions are disposed apart through the resin region.

8. The coil device for wireless power transmission according to claim 2, wherein the coil body is a helical coil;
the magnetic flux conductor has a core portion disposed inside the coil body; and
a plurality of magnetic material regions and a plurality of resin regions are alternately arranged in the core portion.

9. The coil device for wireless power transmission according to claim 3, wherein the coil body is a helical coil;
the magnetic flux conductor has a core portion disposed inside the coil body; and
a plurality of mixed magnetic material regions and a plurality of resin regions are alternately arranged in the core portion.
